(19) United States
(12) Patent Application Publication
(10) Pub. No.: US 2007/0204513 A1
(43) Pub. Date: Sep. 6, 2007

(54) Cassette for Rotating a Louvre Shutter

(76) Inventor: Robert Phillip Griffiths, Mascot (AU)

Correspondence Address: TRASK BRITT, P.O. BOX 2550, SALT LAKE CITY, UT, 84110, US

(21) Appl. No.: 11/629,737

(22) PCT Filed: Jun. 17, 2005
(86) PCT No.: PCT/AU05/00860

§ 371 Date: Mar. 1, 2007

(30) Foreign Application Priority Data
Jun. 17, 2004 (AU) 2004903290

(51) Int. Cl. E06B 7/096

(52) U.S. Cl. 49/82.1

(57) ABSTRACT

A slimline cassette assembly for rotating a louvre blade connected therewith is disclosed. The cassette assembly is capable of fitment within the stile of a frame supporting a plurality of such cassettes and an array of louvre blades connected therewith. The cassette assembly has a body for receiving a pair of straight cut mitre gears therein. The gears are located relative each other so that rotation of a first one of the gears by means of a perpendicular spline shaft connected in axial alignment therewith and extending between corresponding first mitre gears of consecutive cassette assemblies, causes rotation of the other second gear in each cassette assembly about ˜n axis perpendicular to the axis of each first gear. Rotation of the perpendicular shaft is thus imparted uniformly to the array of louvre blades connected in axial alignment with each of the respective second gears of the cassette assemblies.

### TECHNICAL FIELD

This invention relates to a cassette assembly for rotating a louvre shutter or blade or the like. In particular it relates to a slim-line cassette for fitment in the stile of the frame of a louvre shutter assembly, whereby several cassettes may be made to operate together to rotate multiple louvre blades simultaneously.

### BACKGROUND ART

Many systems for rotating multiple louvre shutters have been proposed. In the very simplest solution, a series of louvre blades may be fitted in a frame and caused to rotate together by simply having a connecting rod or the like positioned at some suitable corresponding point on each louvre about which the rod itself can rotate, so that movement of one shutter (or the rod itself) causes the other shutter blades connected thereto, to rotate in like manner.

Such solutions however detract from the aesthetic look of the shutter assembly, since the connecting rod is visible. Accordingly, a solution which is essentially hidden from view would be more desirable.

Other proposals rely on rack and pinion type linkage of a planetary set of blades but this mechanical method does not offer the accuracy of closure of all blades, as does the proposal offered herein.

### OBJECT OF THE INVENTION

It is therefore an object of the present invention to provide a slimline cassette assembly for rotating a louvre shutter which fits discretely within the style of the frame of the shutter assembly and which may be connected with adjacent cassettes located in the style to operate an assembly of louvre blades simultaneously.

### DISCLOSURE OF THE INVENTION

According to one aspect of the present invention there is provided a slimline cassette assembly for rotating a louvre blade connected therewith, the cassette assembly capable of fitment within the stile of a frame supporting a plurality of such cassettes and an array of louvre blades connected therewith, the cassette assembly having a body for receiving a pair of straight cut mitre gears therein, located relative each other so that rotation of a first one of the gears by means of a perpendicular spline shaft connected in axial alignment therewith and extending between corresponding first mitre gears of consecutive cassette assemblies, causes rotation of the other second gear in each cassette assembly about an axis perpendicular to the axis of each first gear, rotation of the perpendicular shaft thus being imparted uniformly to the array of louvre blades connected in axial alignment with each of the respective second gears of the cassette assemblies.

Preferably, each mitre gear has a boss or shaft associated therewith which is located in a corresponding borehole in the body of the cassette assembly to retain the gear therein. In order to facilitate assembly, one of the bore holes, preferably that having the boss of the first mitre gear located therein, is cut away to allow side entry, whilst a ridge or the like allows for snap-in fitment of the boss of the mitre gear in the cassette body, so as to retain same therein.

A bore passing axially through each gear is preferably adapted to receive a shaft passing therethrough, in the case of the first gear the vertical shaft or in the case of the second gear, a shaft, spline or pin supporting each louvre blade. Preferably the bore has a profile complementary to the shape of the shaft which is itself preferably fluted to ensure positive connection. For example, the bores in each of the respective gears have internal fluting or the like to engage with corresponding external fluting on the shaft itself and the spline or pin of each louvre blade. This fluting also acts to assist the assembly of cogent gears in a coordinated position relative to the simultaneous positioning of the blades.

It will be appreciated that whilst a single vertical shaft will extend through its respective gear in order to reach the respective gears of the next cassettes in either or both directions as required, each louvre blade may have a spline extending therefrom, which may be received by the second gear of the cassette assembly or a pin may be located in the second gear for fitment in a corresponding hole in the end of the louvre blade. In either case, preferably the spline or pin is spring loaded to allow for ease of fitment of the louvre blade to the frame of the shutter assembly, the cassettes already having been positioned in the stile.

It will also be appreciated in order that the vertical shaft can extend through a number of cassettes that not only will it pass through consecutive first gears located in each cassette, but will of necessity pass through a bore located opposite the bore in which the first gear is located. Thus a single vertical shaft connects an array of cassettes extending through the bores of consecutive mitre gears as well as the bore located opposite thereto in the cassette body, in order that rotation of the single vertical shaft causes each shutter connected to each of the cassettes through which it passes, to rotate simultaneously.

With advantage, the spacing of each cassette in the stile may be determined by the use of speedclips, cir-clips or other suitable washer means located about the shaft itself to prevent movement of the cassette relative to the shaft. However any other suitable means of locating each cassette relative the next along the shaft may also be employed, including for example by utilising grub screws, etc to attach each first gear to the shaft. Again, other means may be provided to space the assemblies apart, for example by utilising a spacer tube located about that portion of the vertical shaft extending between consecutive cassette assemblies.

Alternatively, the spacer element may be located separately from the shaft. The spacer element may be an unused cassette body. In one such arrangement a pin and complementary hole may be provided to facilitate interlocking between adjacent cassettes, or used to connect consecutive cassettes by means of a hollow tube capable of fitting over the pin of one cassette and mating with the hole of the next adjacent cassette.

Preferably means are also provided to fix one or more of the cassettes in situ in the stile of the frame, once the array of cassettes is fitted together, ready for insertion in the stile. In one embodiment, where the cassette is used in a wooden style, this may be achieved by the use of a screw passing through a hole in a tab or other member such as a lug, extending from the cassette. In other embodiments, where plastic or aluminium stiles are utilised, the location of the cassettes may be achieved by having a covering plate, which receives a portion of the cassette body, for example a rim or lip about the bore hole for the second or horizontal gear, the cassettes being held against the cover plate by means of a strip, eg of nylon, which is pushed down the stile behind the cassettes for that purpose, ie to dock the cassettes in the respective holes in the cover or face of the stile.

The advantage of the cassette of the present invention will be understood when one considers the basic geometry involved, which in essence allows for the shaft and the axis of rotation of each louvre blade to be in the same plane, and not off-set, thereby giving rise to a narrower design than is afforded by any offset arrangement.

With particular advantage, one additional cassette may be fitted in such a way that it is turned at right angles so that instead of turning another louvre blade it acts as a handle, ie has a handle fitted to it which upon turning causes the shaft and hence all the shutters fitted to the respective cassettes through which that shaft passes, to turn. The handle may of course be replaced by a motor arrangement.

Alternatively, the cassette may be so designed that a side portion is cutaway through which a handle element itself or shaft having connection to a motor, and having an appropriate straight cut mitre gear, is inserted, the second gear being removed from the cassette to allow engagement thereof with the first gear in that cassette. This particular cassette for example may be located at the end of the array in that region of the stile adjacent one of the cross members of the frame, eg the bottom rail or some other intermediate cross rail of the frame.

Furthermore, the motor where utilised may be located in the cross member of such a frame, where it may connect directly to the second gear, thus avoiding the need to turn that cassette at right angles.

With particular advantage, a preferred embodiment of the invention includes a tactile resistance positioner, to provide a number of definite steps by which the motion of the shaft is transferred to the louvre blade via the second gear. Preferably this tactile resistance positioner is a spring loaded collar located about the shaft, which acts against a surface on a complimentary bed mounted on the base of the cassette body to provide a number of discrete steps. This is particularly useful in a manually operated system, since the motor will provide positive control over the blade position once it is made to cease rotating the shaft. However, unless there is some form of resistance in a manually operated system, the blades may tend to move from the position in which they have been turned.

### BRIEF DESCRIPTION OF THE DRAWINGS

The invention may be better understood from the following non-limiting description of one or more preferred embodiments, in which:

FIG. 1 is a side elevation of a single cassette assembly according to one aspect of the invention;

FIG. 2 is a perspective view of a single cassette assembly according to one aspect of the invention;

FIG. 3 is an exploded perspective view of an array of cassettes located in an embodiment utilising a wooden frame;

FIG. 4 is an exploded perspective view of an array of cassettes located in an embodiment utilising a plastics frame;

FIG. 5 is an exploded perspective view of an array of cassettes located in an embodiment utilising an aluminium frame:

FIG. 6 is perspective view of a further embodiment of the invention employing a tactile resistance positioned;

FIG. 7 is a top view of the cassette of FIG. 6;

FIG. 8 is a side elevation of the cassette of FIG. 6; and

FIG. 9 is a bottom view of the cassette of FIG. 6.

### DETAILED DESCRIPTION OF THE PREFERRED EMBODIMENTS

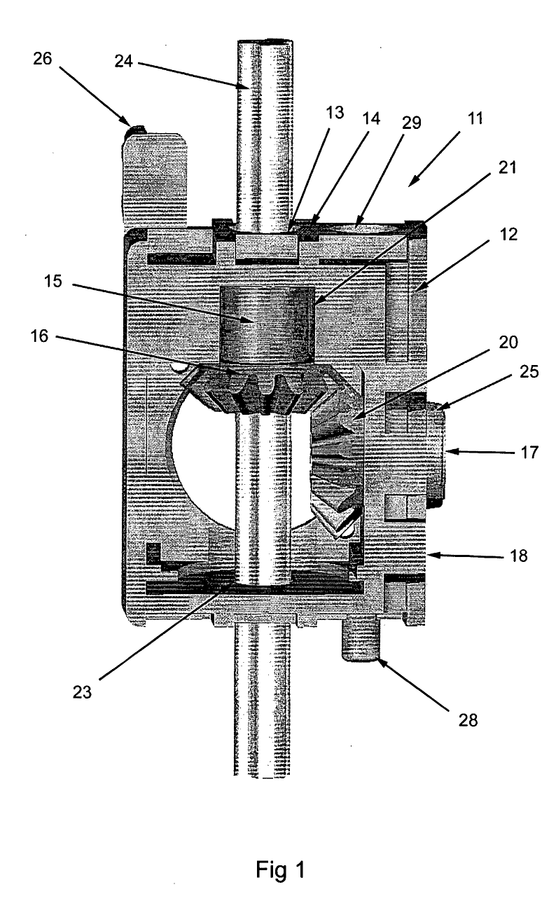

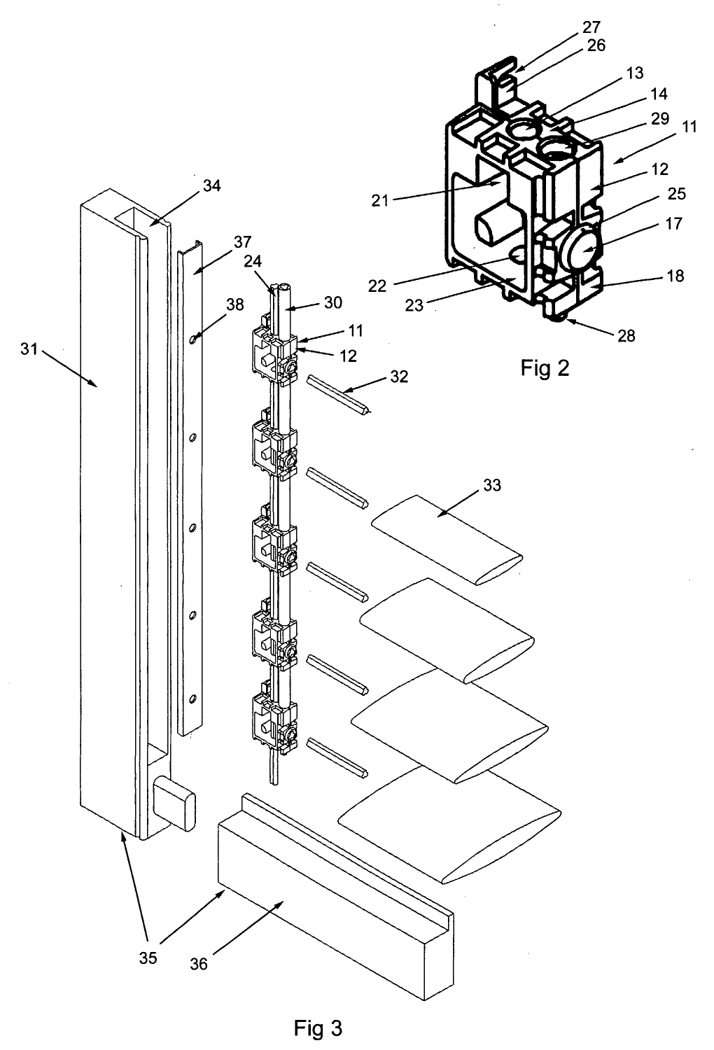

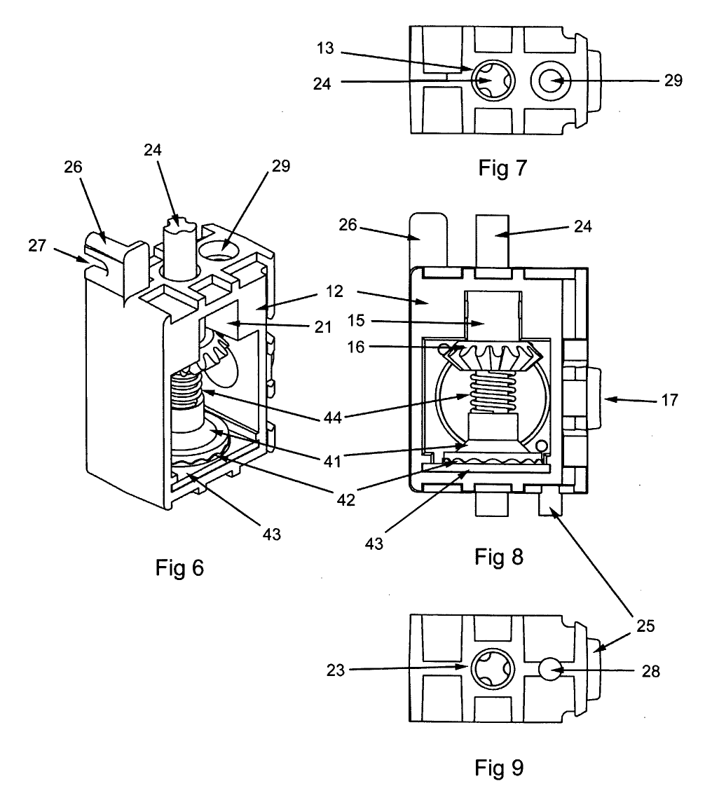

Referring generally to FIGS. 1 and 2 as well FIGS. 6 to 9, there is depicted a cassette 11, comprising a cassette body 12, having a first bore hole 13 located in the upper face 14 thereof for receiving the boss 15 of a first straight cut mitre gear 16. A second bore 17 is located in the front face 18 of the cassette body 12, perpendicular to the first bore 13, for receiving the boss 19 of a second straight cut mitre gear 20. The mitre surfaces of the respective gears mesh in known fashion.

A cutaway portion 21 is provided adjacent the first bore 13 to enable assembly of the two mitre gears 16, 20 in the cassette body 12. The cut away portion 21 is shaped so as to provide a clip-in fit for the boss 15 of the first mitre gear 16.

A third bore hole 22 is located in the base 23 of the cassette body 12 opposite to and in alignment with the first bore hole 13 to accommodate a vertical shaft 24 which extends through consecutive cassettes 11 as shown in FIGS. 3 to 5.

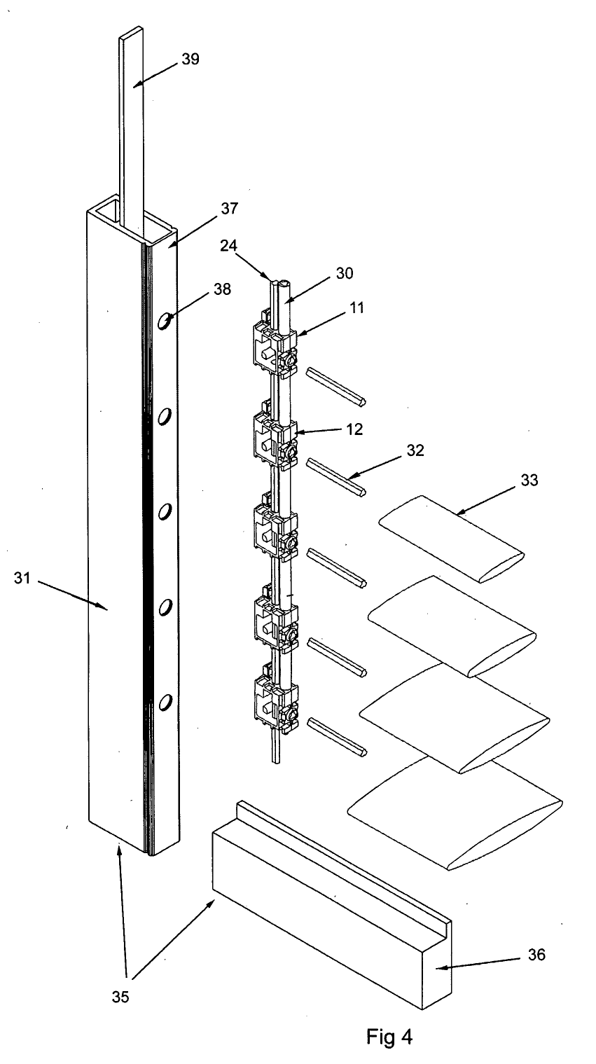

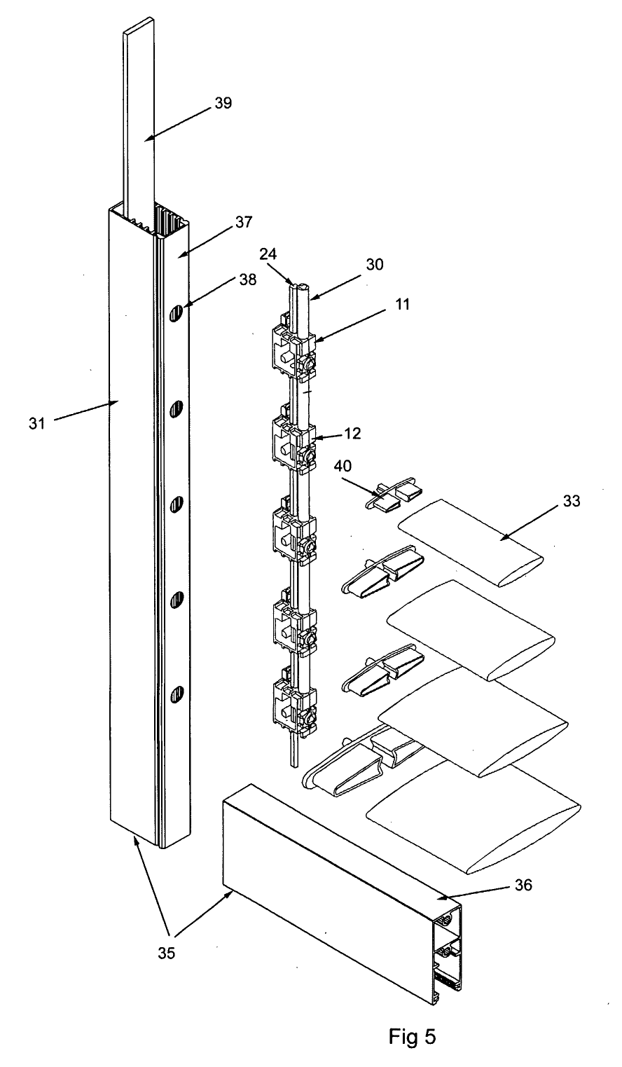

A rim 25 is located about the outer periphery of the second bore 17 to facilitate locating the cassette 11 as described in relation to the embodiments in FIGS. 4 and 5 below.

A lug 26 extends from the rear of the upper face 14 and is provided with a notch 27 for receiving a screw (not shown) for attachment of the cassette 11 in the stile 31 of a timber frame 35 as shown in FIG. 3.

A pin 28 is provided in the base 23 of the cassette body 12 for mating in hole 29 of a consecutive cassette 11. Hole 29 is provided with a stepped arrangement having an inner smaller diameter hole for receiving the pin 28 of a consecutive cassette 11 and a second wider region for locating a spacer shaft 30 as shown in FIGS. 3 to 5 which extends between pins 28 of one cassette 11 and the hole 29 of an adjacent cassette 11.

Referring generally to FIG. 3, there is shown an exploded perspective view of an array of cassettes 11 located on a vertical shaft 24 which extends through each respective first gear 16 located in the first bore hole 13 of each cassette 11 and through each respective third bore 22 in the base 23 of each cassette 11. Preferably the shaft 24 is fluted and mates with corresponding internal fluting in the respective bores in the bosses 15 of the gears 16.

Spacer elements 30 extend between consecutive cassettes 11 as described above to keep the cassettes 11 located the correct distance apart for the size of the louvre blade 33 required.

Blade shafts 32 fit in the bores located in the bosses 19 of second gears 20 located in turn in the second bores 17 of the cassette bodies 12, for locating the chosen size of louvre blade 33. Again, the blade shafts 32 are preferably fluted to engage with corresponding fluting in the bores of bosses 19 of the second gears 20. Although several sizes of blades are shown schematically in FIG. 2, it will be understood that only one size is utilised in each assembly, the space between the adjacent cassettes 11 being adjusted accordingly.

The array of cassettes 11 on shaft 24 is located in rebate 34 of the stile 31 of frame 35 of which the lower cross rail 36 only is shown (besides stile 31). One or more screws may be utilised to secure as many cassettes 11 as is required in the rebate 34 of the stile 31 by means of screws inserted through the notches 27 in the respective lugs 28 as described above.

A cover plate 37 having suitably located holes 38, is located over the array of cassettes 11 to provide a neat finished appearance.

Referring generally to FIG. 4 and FIG. 5, there is shown a similar arrangement to FIG. 3, except that in FIG. 4, a plastics frame is utilised whereas in FIG. 5 an aluminium frame is utilised. Like components as shown in FIG. 3 utilise the same reference numerals. The differences only from FIG. 3 are discussed below. In FIGS. 4 and 5, the cover plate 37 has larger diameter holes 38 to mate with the rim 25 about the second bore hole 17 of each cassette 11. The array of cassettes 11 once assembled on the shaft 24 is thus inserted into stile 31 and the respective rims 25 are caused to align with the holes 38 in the cover plate 37, the assembly being kept in position by the insertion of a backing strip 39, for example of nylon, slid into position behind the array.

The other major difference from FIG. 3 is that the arrangement of FIG. 5 shows instead of a blade shaft 32 supporting a louvre blade 33, an end cap 40 for a hollow aluminium louvre blade 41. Otherwise the array functions in the same manner throughout FIGS. 3 to 5.

With particular advantage, although not shown, a motor may be hidden in the cross rail 36 of the embodiment of FIG. 5, which in this case is hollow.

Otherwise a handle may be conveniently fitted to an additional cassette, for example as discussed above, in the region of the cross rail 36.

In any event, rotation of the shaft 24 in all embodiments, causes the louvre blades 33 attached the second gears 20 to be turned in uniform fashion.

FIGS. 6 to 9 show a further embodiment of the invention utilising a tactile resistance positioner. The same features as found in FIGS. 1 to 5 are identified with the same reference numerals. The tactile positioner consists of a collar 41 mounted on the vertical shaft 24 which is caused to mate against a bed 42 located on the floor 43 of the cassette body 12, by means of spring 44. Each of the components 41 and 42 have complimentary profiles, in this case a series of radially extending flutes forming a hill and valley arrangement, which provides a number of discrete steps by which the rotation of the shaft 24 will be imparted to the second or horizontal gear (not shown in these illustrations for the sake of clarity), which in turn supports and turns the louvre blades as described above.

It will be appreciated by those skilled in the art that many modifications and variations may be made to the embodiments described herein without departing from the spirit or scope of the invention.

Throughout the specification the word “comprise” and its derivatives are intended to have an inclusive rather than exclusive meaning unless the context requires otherwise.

1. A modular slimline cassette assembly for rotating a louver blade connected therewith, the modular cassette assembly capable of fitment within the stile of a frame supporting a plurality of such modular slimline cassette assemblies and an array of louver blades connected with said modular slimline cassette assemblies, said modular cassette assembly having a body for receiving a pair of first and second straight-cut miter gears therein, said first and second miter gears located relative to each other so that rotation of said first miter gear by means of an axial spline shaft connected in axial alignment with said first miter gear along a first axis and extending between corresponding first miter gears of consecutive said modular cassette assemblies, causes rotation of said second-miter gear in each said modular cassette assembly about an axis perpendicular to the first axis, rotation of said axial shaft thus imparting rotation uniformly to said array of louver blades, each said louver blade connected in axial alignment with the corresponding said second miter gear of each said cassette assembly.

2. A modular slimline cassette assembly according to claim 1, wherein said first miter gear has a first boss or shaft associated therewith which is located in a first borehole in the body to retain the gear therein and said second miter gear has a second boss or shaft associated therewith, which second boss or shaft is located in a second borehole in said body to retain said second miter gear therein.

3. A modular slimline cassette assembly according to claim 2, wherein one of said first or second boreholes is cut away to allow side entry for the corresponding said first or second boss or shaft to facilitate assembly of said cassette assembly, while the cut-away portion is shaped to allow for clip-in or snap-in fitment of said first or second boss or shaft of the corresponding said first or second miter gear in the cassette body, so as to retain said first or second boss in said body.

4. A modular slimline cassette assembly according to claim 3, wherein said first borehole is cut away.

5. A modular slimline cassette assembly according to claim 1, in which each said first and second miter gear has a corresponding first or second bore passing axially therethrough and each said first or second miter gear is adapted to receive a corresponding first or second shaft passing therethrough, in the case of the first miter gear, said first shaft being the axial shaft aligned vertically and, in the case of the second miter gear, the shaft being a second shaft, spline or pin supporting each corresponding louver blade.

6. A modular slimline cassette assembly according to claim 5, in which said first and/or said second bore has a profile complementary to the shape of said axial shaft or said second shaft, spline or pin, respectively, which said axial shaft and/or said second shaft, spline or pin is fluted to ensure positive connection.

7. A modular slimline cassette assembly according to claim 5, in which said axial shaft extends vertically through said first miter gear of each said modular cassette assembly in order to reach each adjacent first miter gear of each next cassette in either or both directions as required, said second shaft, spline or pin extending from each said louver blade being a spline or pin, said spline or pin being received by the second miter gear of each said cassette assembly.

8. (canceled)

9. A modular slimline cassette assembly according to claim 7, wherein the spline or pin is spring loaded to allow for ease of fitment of said louver blade to the frame, each said cassette assembly already having been positioned in the stile.

10. (canceled)

11. (canceled)

12. (canceled)

13. A modular slimline cassette assembly according to claim 1, wherein the means of locating each said cassette assembly relative to the next cassette assembly along the axial shaft is by utilizing a spacer tube located about that portion of said axial shaft extending between consecutive cassette assemblies.

14. (canceled)

15. (canceled)

16. A modular slimline cassette assembly according to claim 1, wherein a pin on one cassette assembly and a complementary hole on the opposite end of the next adjacent cassette assembly are provided to facilitate interlocking between adjacent cassette assemblies.

17. A modular slimline cassette assembly according to claim 1, wherein the means of locating each cassette assembly relative to the next along said axial shaft is by means of spacer elements located separately from said axial shaft and a pin on one cassette assembly and a complementary hole on the opposite end of the next adjacent cassette assembly are provided, so that consecutive cassette assemblies are connected by means of said spacer element in the form of a hollow tube capable of fitting over the pin of one cassette assembly and mating with the complementary hole of the next adjacent cassette assembly.

18. (canceled)

19. (canceled)

20. (canceled)

21. A modular slimline cassette assembly according to claim 1, wherein one additional cassette is fitted in such a way that it is turned at right angles so that instead of turning another louver blade, it acts as a handle, by having a handle fitted to it which upon turning, causes said axial shaft and hence all said louver blades fitted to the respective cassette assemblies through which said axial shaft passes, to turn.

22. A modular slimline cassette assembly according to claim 1, wherein one additional cassette assembly comprises a motor arrangement whereby the motor when operated causes said axial shaft to turn and hence all said louver blades fitted to the respective cassette assemblies, through which said axial shaft passes, are turned.

23. (canceled)

24. (canceled)

25. A modular slimline cassette assembly according to claim 1, wherein the modular slimline cassette assembly includes a tactile resistance positioner, to provide a number of definite steps by which the motion of said axial shaft is transferred to said louver blade via the second miter gear.

26. A modular slimline cassette assembly according to claim 25, wherein the tactile resistance positioner is a spring-loaded collar located about said axial shaft, which acts against a surface on a complementary bed mounted on the base of the cassette body to provide a number of discrete steps.

27. (canceled)
